(19) United States
(12) Patent Application Publication
(10) Pub. No.: US 2009/0156722 A1
(43) Pub. Date: Jun. 18, 2009

(54) PVC Compositions

(76) Inventors: Yash P. Khanna, Roswell, GA (US); Edward J. Sare, Macon, GA (US); Jason D. Prince, Sandersville, GA (US); Tonia D. Boutelle, Sandersville, GA (US); Joel M. Zazyczny, Alpharetta, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/158,132

(22) PCT Filed: Dec. 18, 2006
(86) PCT No.: PCT/US06/47932

§ 371 Date: Sep. 19, 2008

Related U.S. Application Data
(60) Provisional application No. 60/752,055, filed on Dec. 21, 2005.

(51) Int. Cl. C08K 5/20; C08K 5/541

(52) U.S. Cl. 524/230; 524/261

(57) ABSTRACT

Disclosed herein are compositions comprising polymers and at least one lubricant comprising at least one silicone oil and at least one oxidized polyethylene. Also disclosed are filled polymer products comprising the compositions disclosed herein as well as mineral fillers, as well as methods of extruding such polymers and the products of the extrusion.

This application claims priority to U.S. Provisional Patent Application No. 60/752,055, filed on Dec. 21, 2005.

Disclosed herein are compositions comprising polymeric materials and at least one lubricant comprising at least one silicone oil and at least one oxidized polyethylene. Also disclosed are filled polymer products comprising the compositions disclosed herein as well as mineral fillers.

Polymer products, such as filled polymer products have become increasingly useful in a variety of applications, including household, electrical, construction, and office equipment products. Examples of such products include adhesives, caulks, sealants, rubbers, plastics, and vinyl sidings. Such polymer products typically comprise an organic or petroleum based resin. Filled polymer products can further comprise an inorganic particulate filler.

Lubricants are often used in such polymer formulations, such as polyvinyl chloride formulations, to increase the rate at which the polymer can be extruded. Lubricants may also result in reduced extrusion temperature, and/or a decrease in extruder power consumption. Lubricants are often added to the polymer resin to aid in processing a polymer product, such as by softening the polymer resin. However, the lubricants may adversely affect the strength of the final polymer product.

Moreover, mineral fillers in filled polymer products can provide an economic advantage in that they allow for the replacement of a portion of the relatively costly polymer with a less costly mineral. However, use of mineral fillers also generally results in negative effects on the toughness and impact strength of the final product. Thus, filled PVC products often also require the use of very expensive impact modifiers to offset the adverse structural effects caused by inclusion of the mineral fillers.

Accordingly, there remains a need to develop lubricant systems for use in processing polymer products.

Disclosed herein is a composition comprising:

at least one polymer; and

at least one lubricant comprising at least one silicone oil and at least one oxidized polyethylene.

In one embodiment, the at least one polymer is chosen from polyvinyl chloride, polyvinylidene chloride, ethylene vinyl alcohol and polychlorotrifluoroethylene.

In one embodiment, the at least one silicone oil can be chosen from organic polysiloxanes, such as polydimethyl siloxanes.

In one embodiment, the at least one oxidized polyethylene can comprise oxidized polyethylene waxes, such as those obtained by oxidative degradation of polyethylene. Without wishing to be bound by any theory, oxidized polyethylene is thought to improve processing by forming a slippery/release layer on the surface of extruder barrels and molds used in the polymer fabrication processes. One such exemplary oxidized polyethylene is commercially available from Honeywell International, AC-629.

In one embodiment, the at least one silicone oil is present in an amount ranging from about 10% to about 90% by weight, relative to the total weight of the lubricant. In another embodiment, at least one silicone oil is present in an amount of at least about 10% by weight relative to the total weight of the oxidized polyethylene, or an amount of up to about 50% by weight relative to the total weight of the oxidized polyethylene, such as an amount ranging from about 30% to about 40%, e.g., about 35% by weight relative to the total weight of the oxidized polyethylene.

In one embodiment, the at least one silicone oil has a viscosity chosen from about 5 cS to about 1000 cS, such as a viscosity chosen from about 100 cS to about 1000 cS, or a viscosity chosen from about 200 cS to about 500 cS. In one embodiment, the viscosity is determined according to the manufacturer's literature for silicone oil, grade SF96-350, GE Advanced Materials, Silicones.

In one embodiment, the at least one lubricant is present in an amount ranging from about 0.1 phr (parts per hundred parts resin) to about 5 phr relative to the amount of the at least one polymer, such as an amount ranging from about 0.5 phr to about 2 phr relative to the amount of the at least one polymer, an amount ranging from about 0.8 phr to about 1.8 phr relative to the amount of the at least one polymer, or an amount ranging from about 1 phr to about 1.3 phr relative to the amount of the at least one polymer.

In one embodiment, the composition can further comprise at least one mineral. Thus, in certain embodiment, the composition can comprise a filled polymer product. Exemplary minerals include inorganic particulate minerals such as those chosen from, but not limited to, calcium carbonate, calcined kaolin, hydrous kaolin, talc, mica, dolomite, silica, zeolite, gypsum, satin white, TiO₂, smectite, and calcium sulphate. One of ordinary skill in the art can readily select suitable minerals to produce a filled polymer product.

In one embodiment, the composition comprises calcium carbonate in an amount ranging from about 0.1 phr to about 30 phr.

In one embodiment, the at least one mineral is present in an amount ranging from about 5% to about 20% by weight, relative to the total weight of the composition, such as an amount ranging from about 7% to about 20% by weight, or an amount ranging from about 10% to about 17% by weight, relative to the total weight of the composition. In another embodiment, the at least one mineral is present in an amount ranging from about 10% to about 30% by weight, such as an amount ranging from about 15% to about 25% by weight, relative to the total weight of the composition.

In one embodiment, the composition further comprises at least one polyethylene.

In one embodiment, the at least one lubricant further comprises at least one additional lubricant other than the at least one silicone oil. The at least one additional lubricant can be chosen from any conventional lubricant known in the art for use with polymer resins, such as those chosen from fatty acids, salts of fatty acids, and fatty amides. Exemplary fatty acids and salts of fatty acids include those chosen from stearic acid and stearates, such as those stearates from sodium stearate, calcium stearate, and aluminum stearate.

In one embodiment, the fatty amides can be saturated or unsaturated fatty amides. Exemplary unsaturated amides include erucamide. Exemplary saturated amides include chosen from stearamides and bis-amides, such as and ethylene bis-stearamide.

In one embodiment, the composition further comprises at least one additional component or additive chosen from stabilizers, impact modifiers, plasticizers, and processing aids. Suitable additives may also include, as known by one of ordinary skill in the art, those additives chosen from coloring agents and stabilizing agents, plasticizers such as dioctyl phthalate and dibutyl phthalate; solvents exemplified by petroleum solvents such as toluene and xylene, ketones such as acetone and methylethylketone, and ether esters such as cellosolve acetate. Various other additives and coloring agents such as solvents (coalescing solvents, alcohols, aldehydes, hydrocarbons, ethers, esters, chlorinated solvents), plasticizers (used in plastisols) including phthalates (e.g., diisooctyl phthalate), adipates, phosphates, and sebacates. Other solvents used in adhesive and sealants can include hydrocarbons, alcohols, esters, ethers.

In one embodiment, the composition allows a reduced amount of impact modifier. In one embodiment, the composition contains no more than about 5 phr of impact modifier, or no more than about 3 phr of impact modifier.

In one embodiment, the composition has a Gardner impact strength of at least about 60 in-lb, such as a Gardner impact strength of at least about 65 in-lb, or a Gardner impact strength of at least about 70 in-lb.

Also disclosed herein is a composition comprising:

at least one polymer,

at least one lubricant comprising at least one silicone oil and at least one oxidized polyethylene; and

at least one mineral filler.

In one embodiment, the composition comprises a filled polymer product. In such filled systems, the use of the at least one lubricant disclosed herein may help to offset any adverse effects of the mineral filler, such as negative effects on toughness and/or impact strength. In one embodiment, the at least one lubricant may allow for reduction or elimination of the relatively costly impact modifier, which should make the use of mineral fillers more desirable. In one embodiment, higher loadings of mineral filler may be achievable if the impact modifier is retained.

In one embodiment, the at least one polymer and the at least one mineral filler can be chosen from the polymers and minerals disclosed herein.

Another embodiment disclosed herein is a method of forming a polymer product comprising:

combining at least one polymer with at least one lubricant comprising at least one silicone oil and at least one oxidized polyethylene.

In one embodiment, the at least one lubricant is combined in the form of a slurry with the at least one polymer.

In one embodiment, the combining comprises providing adding the components one at a time, or simultaneously.

In another embodiment, the blending further comprises blending at least one additional component chosen from stabilizers, impact modifiers, and processing aids.

In one embodiment, the method further comprises extruding the product of the blending. Extrusion of polymers is a technique well known to one of ordinary skill in the art. In one embodiment, extrusion is performed according to The Concise Encyclopedia of Polymer Science & Engineering, John Wiley & Sons, New York (1991). In one embodiment, the extruding is performed at a temperature ranging from about 170° C. to about 230° C.

Another embodiment disclosed herein includes extruded polymer products. Exemplary products include paints, architectural coatings, industrial coatings, adhesives, caulks, and sealants, e.g., polysulphide sealing compositions, adhesives or caulks, and sheet molding compositions.

In one embodiment, the composition disclosed herein has a Gardner impact strength of at least about 60 in-lb and further comprises up to about 30 phr of CaCO₃, and up to about 5 phr of at least one impact modifier, wherein the composition was extruded at a temperature ranging from about 170 to about 230° C.

### EXAMPLES

The general materials and methods for the following Examples are provided below.

### Materials

(1) Polyvinyl chloride (PVC) powder resin, OxyVinyls™ 222S, medium molecular weight with a Relative Viscosity of 2.19 (1% in cyclohexanone @25 C) designed for rigid applications was obtained from Oxy Vinyls, LP;
(2) Heat stabilizer, methyltin mercaptide/sulfide (Mark 1925) was obtained from Crompton Corporation;
(3) Oxidized polyethylene homopolymer wax, AC-629A, was obtained from Honeywell International;
(4) Functionalized polyethylene wax, Epolene EP-14, was obtained from Eastman Chemical;
(5) Calcium stearate, S-1244 was obtained from Nuodex Inc.; a Huls Company.
(6) Silicone oil, grade SF96-350, a polydimethylsiloxane of high viscosity, was obtained from GE Advanced Materials;
(7) Impact modifier, methylmethacrylate/acrylic copolymer (FM-25) was received from Kaneka Texas Corporation;
(8) Processing aid, methylmethacrylatelacrylic copolymer (PA-10) was also obtained from Kaneka Texas Corporation; and
(9) Titanium dioxide, TiO₂, brand name CR-80, was received from Kerr McGee.

Blending Procedure

PVC powder (100 parts) was added to a mixing device that was pre-heated to 38° C. and operating at 3000 RPM. As the mixing continued the temperature was increased and the other ingredients were added successively as follows: heat stabilizer at 60° C., lubricant systems at 68° C., and the processing aid at 85° C. The inventive lubricant systems, as disclosed in more detail below, were applied in the form of a slurry where the powdered lubricants were added to the silicone oil and stirred mechanically to create a stable suspension. The entire mixture was allowed to mix until a temperature of about 108° C. was reached. It was then discharged into a container and allowed to cool to room temperature, overnight. Calcium carbonate was added to the mixture in desired amounts and allowed to mix for about 60 seconds ensuring that the temperature did not rise to any significant extent.

Extrudate Processing

The mixture above was formed into strips of about 45 mm width and 1 mm thickness (0.04 inch or 40 mils) on a Leistritz machine (15 L/D) configured in 5 zones and equipped with a 34 mm counter-rotating twin screw. The powder mixture was fed upstream at zone 1 and a vacuum was applied for de-gassing at zone 3. The temperature profile was set at 185° C. For each composition, the extruder was stripped-off, cleaned, re-assembled, and sample collected for testing after 60 minutes of extrusion time.

Impact Testing

Extruded strips were equilibrated overnight. Impact Strength was tested using a Pacific Instruments Gardner Impact Tester and a 4 lb falling weight striker according to ASTM D 5420.

### Example 1

This Example provides a comparative test between a typical vinyl siding industry lubricant/processing aid package at a loading of 2.85 phr (parts per hundred parts resin) versus two inventive compositions at a loading of 1.0 phr under otherwise similar preparation and processing conditions. The components are shown in Table I, below.

TABLE I

| | | | Impact | | | |
|---|---|---|---|---|---|---|
| | | Extrudate | Strength | | Extrudate | Extruder |
| | Components | Thickness | Gardner | Extruder | Temp. | Throughput |
| Composition | (phr) | (mils) | (in-lb) | (Amps) | (° C.) | (lbs/hour) |
| Industry | PVC: 100.00 | 40 | 58 | 15 | 205 | 17.0 |
| Standard | Stabilizer: 0.80 | | | | | |
| | Lub/Process | | | | | |
| | Aid: 2.85⁽¹⁾ | | | | | |
| | Impact Modifier: | | | | | |
| | 3.00 | | | | | |
| | TiO₂: 0.50 | | | | | |
| | CaCO₃: 13.00 | | | | | |
| Inventive | PVC: 100.00 | 42 | 69 | 15 | 205 | 16.9 |
| System 1 | Stabilizer: 0.80 | | | | | |
| | Lub System-1: | | | | | |
| | 1.00⁽²⁾ | | | | | |
| | Impact Modifier: | | | | | |
| | 3.00 | | | | | |
| | TiO₂: 0.50 | | | | | |
| | CaCO_{3:} 13.00 | | | | | |
| Inventive | PVC: 100.00 | 41 | 81 | 14 | 202 | 16.8 |
| System 2 | Lub System-2: | | | | | |
| | 1.00⁽³⁾ | | | | | |
| | Impact Modifier: | | | | | |
| | 3.00 | | | | | |
| | TiO₂: 0.50 | | | | | |
| | CaCO₃: 13.00 | | | | | |

⁽¹⁾1.0 phr calcium stearate, 1.0 phr of oxidized polyethylene (AC629), 0.1 phr of polyethylene wax (Epolene E-14P) and 0.75 phr of an acrylate processing aid (Kaneka PA-10).
⁽²⁾1.0 phr of a slurry based on 66% silicone oil (GE's SF96-350), 17% Erucamide, and 17% of oxidized polyethylene (AG629).
⁽³⁾1.0 phr of a slurry based on 66% silicone oil (GE's SF96-350), 17% Calcium Stearate, and 17% of oxidized polyethylene (AC629).

It is evident from the data of Table I that Inventive Lubricant Systems 1 and 2 led to a significantly better product performance in terms of impact strength (69 or 81 for the inventive product versus 58 in-lb for the industry standard) while improving the extrusion process, as indicated by, for example, lower extrudate temperature and lower extruder amperes.

### Example 2

This Example also shows that inventive Lubricant System 2 leads to a significantly better product performance (74 vs 52 in-lb) in terms of impact strength while improving the extrusion process, for example, lower extrudate temperature and lower extruder amperes. The components are shown in Table II, below.

TABLE II

| | | | Impact | | | |
|---|---|---|---|---|---|---|
| | | Extrudate | Strength, | | Extrudate | Extruder |
| | Components | Thickness | Gardner | Extruder | Temp. | Throughput |
| Composition | (phr) | (mils) | (in-lb) | (Amps) | (° C.) | (lbs/hour) |
| Industry | PVC: 100.00 | 40 | 52 | 17 | 205 | 17.3 |
| Standard | Stabilizer: 0.80 | | | | | |
| | Lub/Process | | | | | |
| | Aid: 2.85⁽¹⁾ | | | | | |
| | Impact Modifier: | | | | | |
| | 3.00 | | | | | |
| | TiO₂: 0.50 | | | | | |
| | CaCO₃: 13.00 | | | | | |
| Inventive | PVC: 100.00 | 40 | 74 | 14 | 202 | 16.7 |
| System 2 | Stabilizer: 0.80 | | | | | |
| | Impact Modifier | | | | | |
| | 3.00 | | | | | |
| | TiO₂: 0.50 | | | | | |
| | CaCO₃: 13.00 | | | | | |
| | Lub System-2: | | | | | |
| | 1.00⁽²⁾ | | | | | |
| Inventive | Same as above | 40 | 65 | 14 | 205 | 16.8 |
| System 3 | except: | | | | | |
| | Lub System-3: | | | | | |
| | 1.00⁽³⁾ | | | | | |
| Inventive | Same as above | 41 | 57 | 14 | 203 | 17.0 |
| System 4 | except: | | | | | |
| | Lub System-4: | | | | | |
| | 1.00⁽⁴⁾ | | | | | |
| Inventive | Same as above | 41 | 72 | 14 | 204 | 16.6 |
| System 5 | except: | | | | | |
| | Lub System-5: | | | | | |
| | 1.00⁽⁵⁾ | | | | | |
| Inventive | Same as above | 41 | 66 | 16 | 204 | 16.6 |
| System 6 | except: | | | | | |
| | Lub System-6: | | | | | |
| | 1.00⁽⁶⁾ | | | | | |
| Inventive | Same as above | 41 | 29 | 15 | 202 | 16.5 |
| System 7 | except: | | | | | |
| | Lub System-7: | | | | | |
| | 1.00⁽⁷⁾ | | | | | |
| Inventive | Same as above | 42 | 85 | 15 | 204 | 16.3 |
| System 8 | except: | | | | | |
| | Lub System-8: | | | | | |
| | 1.00⁽⁸⁾ | | | | | |

⁽¹⁾1.0 phr Calcium Stearate, 1.0 phr of oxidized polyethylene (AC629), 0.1 phr of polyethylene wax (Epolene E-14P) and 0.75 phr of an acrylate processing aid (Kaneka PA-10).
⁽²⁾1.0 phr of a slurry based on 66% silicone oil (SF96-350, GE), 17% Calcium Stearate, and 17% of oxidized polyethylene (AC629).
⁽³⁾1.0 phr silicone oil (SF96-350, GE) ONLY.
⁽⁴⁾1.0 phr of Calcium Stearate ONLY.
⁽⁵⁾1.0 phr of oxidized polyethylene (AC629) ONLY.
⁽⁶⁾1.0 phr of equal amounts of Calcium Stearate, and oxidized polyethylene (AC629).
⁽⁷⁾1.0 phr of a slurry based on 66% silicone oil (GE's SF96-350) and 34% Calcium Stearate.
⁽⁸⁾1.0 phr of a slurry based on 66% silicone oil (GE's SF96-350) and 34% oxidized polyethylene (AC629).

Unexpectedly, it was observed that inventive Lubricant System 2 exhibited an improved performance compared to Systems 3-7, which comprise the individual components of Lubricant System 2. For example, at the same lubricant loading of 1.0 phr, a slurry of silicone oil, calcium stearate, and AC 629 wax was better than either a system containing silicone oil alone, calcium stearate alone, or AC 629 wax alone. Similarly, Inventive Lubricant System 8 exhibited an improved performance compared to the components it is comprised of, for example, at the same lubricant loading of 1.0 phr, a slurry of silicone oil and AC 629 wax exhibited a higher impact strength than systems comprising either silicone oil alone or AC 629 wax alone. This improved performance between silicone oil and conventional lubricants, was totally unexpected.

Example 3 compares product characteristics based on the amount of the inventive lubricant system. The components are shown in Table III, below.

TABLE III

| | | Impact | | | |
|---|---|---|---|---|---|
| | Extrudate | Strength, | | Extrudate | Extruder |
| | Thickness | Gardner | Extruder | Temp | Throughput |
| Composition | (mils) | (in-lb) | (Amps) | (° C.) | (lbs/hour) |
| PVC: 100.00 | 40 | 50 | 14 | 200 | 16.5 |
| Stabilizer: 0.80 | | | | | |
| Impact Modifier: 3.00 | | | | | |
| TiO₂: 0.50 | | | | | |
| CaCO₃: 13.00 | | | | | |
| Lub System-2⁽¹⁾: 0.80 | | | | | |
| Same as above except | 40 | 74 | 14 | 202 | 16.7 |
| Lub System-2⁽¹⁾: 1.00 | | | | | |
| Same as above except | 40 | 85 | 14 | 202 | 16.8 |
| Lub System-2⁽¹⁾: 1.10 | | | | | |
| Same as above except | 41 | 81 | 13 | 197 | 16.2 |
| Lub System-2⁽¹⁾: 1.20 | | | | | |
| Same as above except | 41 | 57 | 14 | 196 | 17.1 |
| Lub System-2⁽¹⁾: 1.60 | | | | | |

⁽¹⁾A slurry based on 66% silicone oil (GE's SF96-350), 17% Calcium Stearate, and 17% of oxidized polyethylene (AC629).

Using Inventive Lubricant system-2, an amount of 1.1 phr was found to be the most optimal. If the lubricant amount is low, not only the impact strength is poor but also the polymer degrades causing the discoloration & charring of the product. On the other hand, if the lubricant is high, the polymer particles do not fuse and the product exhibits a poor impact strength.

### Example 4

Example 4 compares product characteristics of a product containing an inventive lubricant system versus and industry standard. The components are shown in Table IV, below.

TABLE IV

| | | | Impact |
|---|---|---|---|
| | | Extrudate | Strength |
| | Components | Thickness, | Gardner, |
| Composition | phr | (Mils) | (in-lb) |
| Industry | PVC: 100.00 | 41 | 43 |
| Standard | Stabilizer: 0.80 | | |
| | TiO₂: 0.50 | | |
| | CaCO₃: 13.00 | | |
| | Lub/Process | | |
| | Aid: 2.85⁽¹⁾ | | |
| Inventive | PVC: 100.00 | 40 | 77 |
| System | Stabilizer: 0.80 | | |
| | TiO₂: 0.50 | | |
| | CaCO₃: 13.00 | | |
| | Lub System-8: | | |
| | 1.00⁽⁸⁾ | | |

⁽¹⁾1.0 phr Calcium Stearate, 1.0 phr of oxidized polyethylene (AC629), 0.1 phr of polyethylene wax (Epolene E-14P) and 0.75 phr of an acrylate processing aid (Kaneka PA-10).
⁽²⁾1.1 phr of a slurry based on 66% silicone oil (GE's SF96-350) and 34% oxidized polyethylene (AC629).

### Example 5

This Example demonstrates how an inventive lubricant system can result in a polymer product having a suitable impact strength with the use of a lower amount of impact modifier while increasing the amount of calcium carbonate. Calcium carbonate is used often as a cheaper substitute for the more expensive resin. Typically, the use of more added calcium carbonate is desired from a cost perspective. However, adding calcium carbonate typically decreases impact strength. The inventive lubricants allow use of reasonably high levels of calcium carbonate filler without adversely affecting impact strength

The first entry in Table V below shows a decreased impact strength value of a polymer product due to an increased amount of calcium carbonate (compare with, for example, “Inventive System-8” of Table II). The second entry of Table V demonstrates that even when the amount of impact modifier was decreased while the increased amount of calcium carbonate was maintained, the impact strength increased by optimizing the extrusion temperature.

TABLE V

| | | | | Impact |
|---|---|---|---|---|
| | Processing | Impact | Extrudate | Strength, |
| Components | Temp. | Modifier | Thickness | Gardner |
| phr | (° C.) | (phr) | (Mils) | (in-lb) |
| PVC: 100.00 | 185 | 3 | 40 | 47 |
| Stabilizer: 0.80 | | | | |
| TiO₂: 0.50 | | | | |
| CaCO₃: 20.00 | | | | |
| Lub System-8: | | | | |
| 1.10¹ | | | | |
| PVC: 100.00 | 195 | 1 | 40 | 72/69 |
| Stabilizer: 0.80 | | | | |
| Lub System-8: | | | | |
| 1.0¹ | | | | |
| TiO₂: 0.50 | | | | |
| CaCO₃: 20.00 | | | | |

¹1.1 phr of a slurry based on 66% silicone oil (GE's SF96-350) and 34% oxidized polyethylene (AC629)

As shown, by optimizing the extrusion temperature the impact strength of the formulation can be enhanced while, surprisingly, increasing the loading of CaCO₃ to 20 phr and decreasing the amount of the impact modifier.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A composition comprising:
at least one polymer chosen from polyvinyl chloride, polyvinylidene chloride, ethylene vinyl alcohol and polychlorotrifluoroethylene; and
at least one lubricant comprising at least one silicone oil and at least one oxidized polyethylene.

2. The composition according to claim 1, further comprising at least one mineral.

3. The composition according to claim 2, wherein the at least one mineral is chosen from calcium carbonate, calcined kaolin, hydrous kaolin, talc, mica, dolomite, silica, zeolite, gypsum, satin white, TiO₂, smectite, and calcium sulphate.

4. The composition according to claim 2, wherein the at least one mineral comprises calcium carbonate.

5. The composition according to claim 4, wherein the composition comprises calcium carbonate in an amount ranging from about 0.1 phr to about 30 phr.

6. The composition according to claim 2, wherein the at least one mineral comprises TiO₂.

7. The composition according to claim 2, wherein the at least one mineral is present in an amount ranging from about 5% to about 20% by weight, relative to the total weight of the composition.

8. The composition according to claim 2, wherein the at least one mineral is present in an amount ranging from about 7% to about 20% by weight, relative to the total weight of the composition.

9. The composition according to claim 2, wherein the at least one mineral is present in an amount ranging from about 10% to about 17% by weight, relative to the total weight of the composition.

10. The composition according to claim 1, further comprising at least one polyethylene.

11. The composition according to claim 1, wherein the at least one lubricant further comprises at least one additional lubricant other than the at least one silicone oil.

12. The composition according to claim 11, wherein the at least one additional lubricant is chosen from fatty acids, salts of fatty acids, and fatty amides.

13. The composition according to claim 12, wherein the fatty acids and salts of fatty acids are chosen from stearic acid and stearate.

14. The composition according to claim 13, wherein the stearate is chosen from sodium stearate, calcium stearate, and aluminum stearate.

15. The composition according to claim 13, wherein the fatty amides are chosen from stearamides.

16. The composition according to claim 13, wherein the fatty amides are chosen from erucamide and ethylene bis-stearamide.

17. The composition according to claim 11, wherein the at least one silicone oil is present in an amount ranging from about 10% to about 90% by weight, relative to the total weight of the lubricant.

18. The composition according to claim 1, wherein the at least one silicone oil is chosen from organic polysiloxanes.

19. The composition according to claim 18, wherein the siloxanes are chosen from polydimethyl siloxanes.

20. The composition according to claim 1, wherein the at least one silicone oil has a viscosity chosen from about 5 cS to about 1000 cS.

21. The composition according to claim 1, wherein the at least one silicone oil has a viscosity chosen from about 100 cS to about 1000 cS

22. The composition according to claim 1, wherein the at least one silicone oil has a viscosity chosen from about 200 cS to about 500 cS

23. The composition according to claim 1, wherein the at least one lubricant is present in an amount ranging from about 0.1 phr to about 5 phr relative to the amount of the at least one polymer.

24. The composition according to claim 1, wherein the at least one lubricant is present in an amount ranging from about 0.5 phr to about 2 phr relative to the amount of the at least one polymer.

25. The composition according to claim 1, wherein the at least one lubricant is present in an amount ranging from about 0.8 phr to about 1.8 phr relative to the amount of the at least one polymer.

26. The composition according to claim 1, wherein the at least one lubricant is present in an amount ranging from about 1 phr to about 1.3 phr relative to the amount of the at least one polymer.

27. The composition according to claim 1, further comprising at least one additional component chosen from stabilizers, impact modifiers, and processing aids.

28. The composition according to claim 1, wherein the composition comprises an impact modifier in an amount no more than about 5 phr.

29. The composition according to claim 1, wherein the composition comprises an impact modifier in an amount no more than about 3 phr.

30. The composition according to claim 1, wherein the composition has a Gardner impact strength of at least about 60 in-lb.

31. The composition according to claim 1, wherein the composition has a Gardner impact strength of at least about 65 in-lb.

32. The composition according to claim 1, wherein the composition has a Gardner impact strength of at least about 70 in-lb.

33. The composition according claim 1, comprising up to about 30 phr of CaCO₃, up to about 5 phr of at least one impact modifier, wherein the composition was extruded at a temperature ranging from about 170° C. to about 230° C.

34. A composition comprising:
at least one polymer;
at least one lubricant comprising at least one silicone oil and at least one oxidized polyethylene; and
at least one mineral filler.

35. The composition according to claim 34, wherein the at least one polymer is chosen from polyethylene, polypropylene, polystyrene, polyamides, polyesters, ethylene vinylalcohol copolymer, polyvinyl chloride, and copolymers and blends thereof.

36. The composition according to claim 34, wherein the at least one polymer is chosen from polyvinyl chloride, polyvinylidene chloride, ethylene vinyl alcohol and polychlorotrifluoroethylene.

37. The composition according to claim 34, wherein the at least one mineral is chosen from calcium carbonate, calcined kaolin, hydrous kaolin, talc, mica, dolomite, silica, zeolite, gypsum, satin white, TiO₂, smectite, and calcium sulphate.

38. A method of forming a polymer product comprising:
combining at least one polymer with at least one lubricant comprising at least one silicone oil and at least one oxidized polyethylene.

39. The method according to claim 38, wherein the at least one lubricant is combined in the form of a slurry with the at least one polymer.

40. The method according to claim 38, wherein the blending further comprises blending at least one additional component chosen from stabilizers, impact modifiers, and processing aids.

41. The method according to claim 38, further comprising extruding the product of the blending.

42. The method according to claim 41, wherein the extruding is performed at a temperature ranging from about 170° C. to about 230° C.

43. An extruded polymer comprising the product of claim 38.
